(19) United States
(12) Patent Application Publication
(10) Pub. No.: US 2025/0010602 A1
(43) Pub. Date: Jan. 9, 2025

(54) METHOD FOR MANUFACTURING STRETCHABLE DEVICE

(71) Applicant: Japan Display Inc., Tokyo (JP)

(72) Inventor: Yosuke HYODO, Tokyo (JP)

(21) Appl. No.: 18/758,438

(22) Filed: Jun. 28, 2024

(30) Foreign Application Priority Data
Jul. 3, 2023 (JP) 2023-109384

(51) Int. Cl. B32B 37/12; B32B 7/12; B32B 27/08; B32B 37/24

(52) U.S. Cl. CPC B32B 37/12; B32B 7/12; B32B 27/08; B32B 37/24; B32B 2037/243; B32B 2307/51; B32B 2457/00

(57) ABSTRACT

According to an aspect, a method for manufacturing a stretchable device includes: preparing a glass plate provided with an inorganic film; forming a resin base member on the inorganic film; forming an array layer on the resin base member; and bonding a stretchable resin to the array layer. The bonding the stretchable resin includes arranging part of the stretchable resin in a through hole that passes through the resin base member and the array layer and bonding the part of the stretchable resin to the inorganic film. The inorganic film has a formation surface on which the resin base member is formed. The formation surface has a recess recessed toward the glass plate.

### CROSS-REFERENCE TO RELATED APPLICATION

This application claims the benefit of priority from Japanese Patent Application No. 2023-109384 filed on Jul. 3, 2023, the entire contents of which are incorporated herein by reference.

### BACKGROUND

### 1. Technical Field

What is disclosed herein relates to a method for manufacturing a stretchable device.

### 2. Description of the Related Art

Stretchable devices have excellent elasticity and flexibility. Stretchable devices include an array layer, a resin base member serving as a base member for the array layer, and two stretchable resins that sandwich the array layer and the resin base member. As described in Japanese Patent Application Laid-open Publication No. 2021-118273, for example, the resin base member has a plurality of through holes passing through the resin base member in the thickness direction. The through holes are arrayed in a matrix (row-column configuration). Therefore, the resin base member includes a plurality of hinges extending between the through holes and a plurality of bodies to which the ends of the hinges are coupled. The hinges have a meandering shape.

The process of manufacturing a stretchable device is as follows: a resin base member is formed on a glass plate. Next, an array layer is formed on the resin base member. Subsequently, a stretchable resin is arranged to cover the array layer and is pressure-bonded to the array layer. Part of the stretchable resin is extruded through the through holes in the resin base member and adheres to the glass plate. When removing the resin base member from the glass plate, the stretchable resin is hard to remove from the glass plate due to its high adhesiveness. This may undesirably damage or deform the resin base member and the array layer. In addition, etching for forming the resin base member may erode the glass plate and contaminate a chamber. Therefore, there is a desire to prevent contamination of the chamber.

For the foregoing reasons, there is need for a method for manufacturing a stretchable device that can improve removability of a stretchable resin and prevent contamination of a chamber.

### SUMMARY

According to an aspect, a method for manufacturing a stretchable device includes: preparing a glass plate provided with an inorganic film; forming a resin base member on the inorganic film; forming an array layer on the resin base member; and bonding a stretchable resin to the array layer. The bonding the stretchable resin includes arranging part of the stretchable resin in a through hole that passes through the resin base member and the array layer and bonding the part of the stretchable resin to the inorganic film. The inorganic film has a formation surface on which the resin base member is formed. The formation surface has a recess recessed toward the glass plate.

### BRIEF DESCRIPTION OF THE DRAWINGS

FIG. 1 is a perspective view of a stretchable device according to a first embodiment;

FIG. 2 is a schematic of a section of the stretchable device according to the first embodiment, and more specifically a sectional view along line II-II of FIG. 3;

FIG. 3 is a plan view of a resin base member disposed on a first surface of a first stretchable resin according to the first embodiment viewed from a first thickness direction;

FIG. 4 is an enlarged view of bodies and a hinge according to the first embodiment;

FIG. 5 is an enlarged view of the bodies and the hinge when a tensile load acts on the resin base member according to the first embodiment;

FIG. 6 is a flowchart of the first half of the method for manufacturing the stretchable device according to the first embodiment;

FIG. 7 is a flowchart of the second half of the method for manufacturing the stretchable device according to the first embodiment;

FIG. 8 is an enlarged view of a section cut in the thickness direction of an intermediate product at a second stretchable resin arrangement step;

FIG. 9 is an enlarged view of a glass plate according to the first embodiment viewed from the first thickness direction;

FIG. 10 is an enlarged view of a section of the stretchable device manufactured by the manufacturing method according to the first embodiment;

FIG. 11 is an enlarged view of part of a formation surface of an inorganic film according to a first modification viewed from the first thickness direction;

FIG. 12 is an enlarged view of part of the formation surface of the inorganic film according to a second modification viewed from the first thickness direction;

FIG. 13 is an enlarged view of part of the formation surface of the inorganic film according to a third modification viewed from the first thickness direction; and

FIG. 14 is a sectional view cut in the thickness direction of an intermediate product after the second stretchable resin arrangement step in the manufacturing method according to a second embodiment.

### DETAILED DESCRIPTION

Exemplary aspects (embodiments) to embody the present disclosure are described below in greater detail with reference to the accompanying drawings. The contents described in the embodiments below are not intended to limit the disclosure according to the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may possibly illustrate the width, the thickness, the shape, and other elements of each unit more schematically than the actual aspect. These elements, however, are given by way of example only and are not intended to limit interpretation of the present disclosure. In the present specification and the drawings, components similar to those previously described with reference to previous drawings are denoted by the same reference numerals, and detailed explanation thereof may be appropriately omitted.

When the term “on” is used to describe an aspect where a first structure is disposed on or above a second structure in the present specification and the claims, it includes both of the following cases unless otherwise noted: a case where the first structure is disposed on and in contact with the second structure, and a case where the first structure is disposed above the second structure with still another structure interposed therebetween.

### First Embodiment

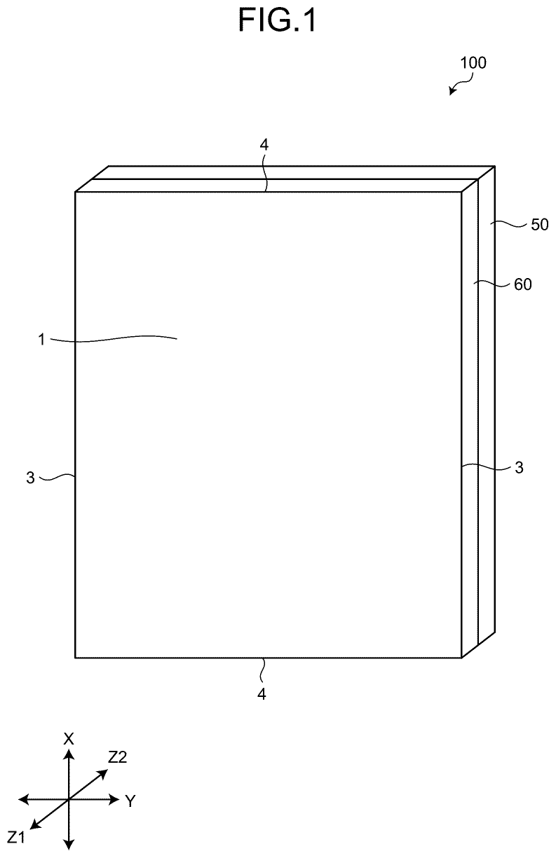

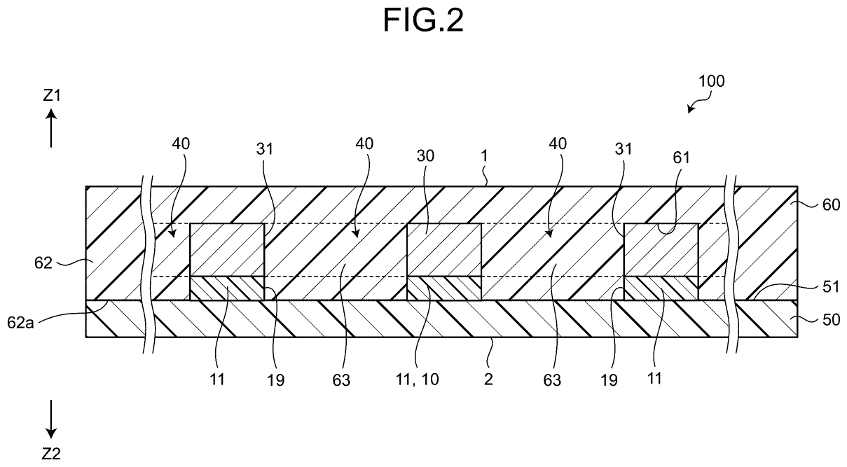

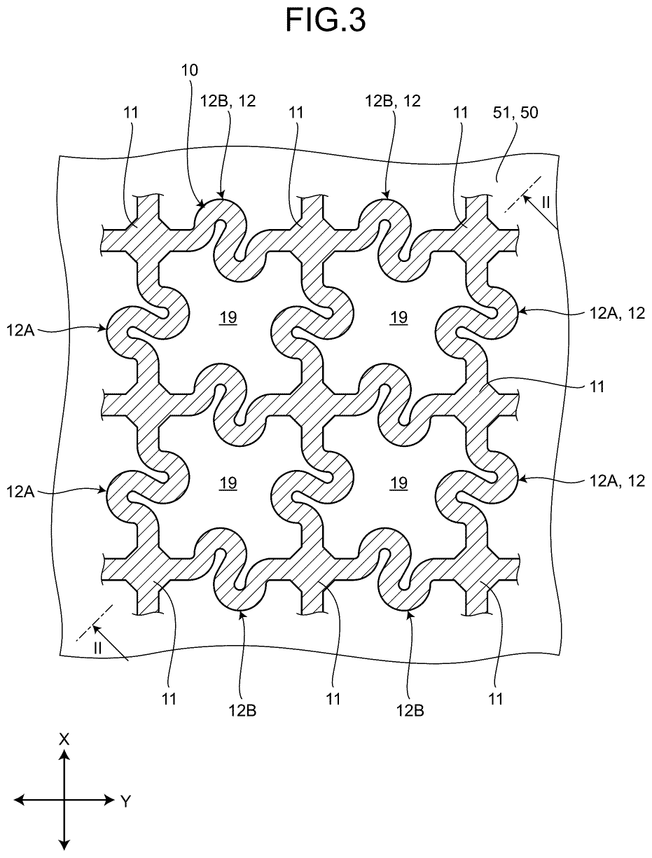

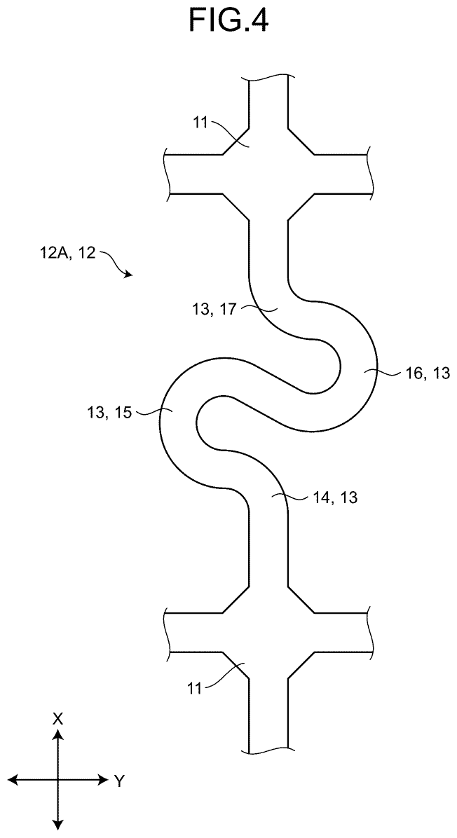

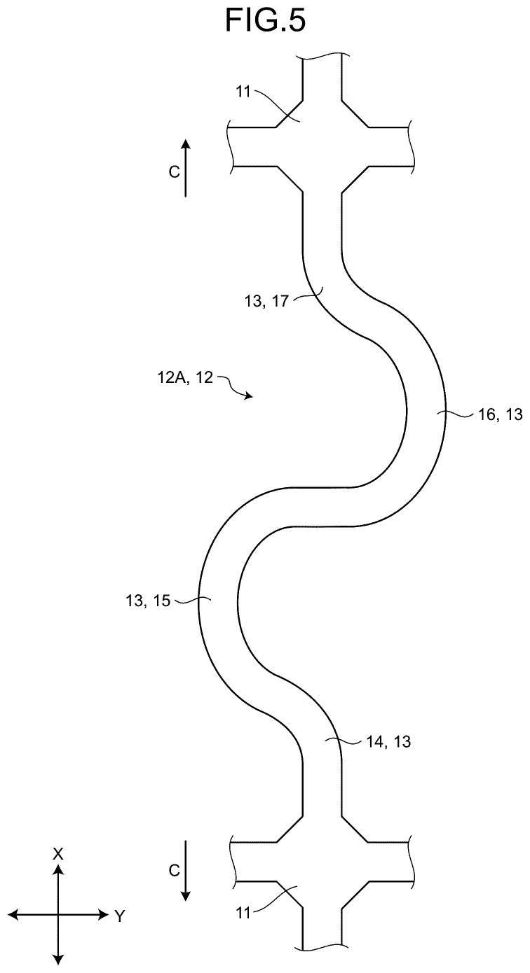

FIG. 1 is a perspective view of a stretchable device according to a first embodiment. FIG. 2 is a schematic of a section of the stretchable device according to the first embodiment, and more specifically a sectional view along line II-II of FIG. 3. FIG. 3 is a plan view of a resin base member disposed on a first surface of a first stretchable resin according to the first embodiment viewed from a first thickness direction. FIG. 4 is an enlarged view of bodies and a hinge according to the first embodiment. FIG. 5 is an enlarged view of the bodies and the hinge when a tensile load acts on the resin base member according to the first embodiment. In FIG. 3, a resin base member 10 is hatched to make it easy to see the resin base member 10.

First, the structure of a stretchable device 100 is briefly described. As illustrated in FIGS. 1 and 2, the stretchable device 100 is formed in a plate shape. The stretchable device 100 has a surface 1 and a back surface 2 (not illustrated in FIG. 1, and refer to FIG. 2) facing opposite to each other. In the following description, the direction parallel to the surface 1 and the back surface 2 is referred to as a planar direction.

As illustrated in FIG. 1, the stretchable device 100 is formed in a rectangular shape when viewed in the direction facing the surface 1. In other words, the surface 1 has a pair of long sides 3 and a pair of short sides 4. In the following description, the direction parallel to the long side 3 is referred to as a longitudinal direction X, and the direction parallel to the short side 4 is referred to as an intersecting direction Y.

As illustrated in FIG. 2, the stretchable device 100 includes a first stretchable resin 50, a resin base member 10, an array layer 30, and a second stretchable resin (stretchable resin) 60 stacked in the order as listed. The direction in which the first stretchable resin 50, the resin base member 10, the array layer 30, and the second stretchable resin 60 are stacked is hereinafter referred to as a thickness direction. In the thickness direction, the direction in which the second stretchable resin 60 is disposed when viewed from the first stretchable resin 50 is referred to as a first thickness direction Z1, and the direction opposite to the first thickness direction Z1 is referred to as a second thickness direction Z2. The view of the stretchable device 100 from the first thickness direction Z1 is referred to as plan view.

The first stretchable resin 50 and the second stretchable resin 60 have insulating, elastic, and flexible properties. The resin used as the first stretchable resin 50 and the second stretchable resin 60 is acrylic elastomer, for example. The first stretchable resin 50 and the second stretchable resin 60 according to the present disclosure are not limited to acrylic elastomer. They may be acrylic resin, epoxy resin, urethane resin, or the like and are not particularly limited.

The first stretchable resin 50 and the second stretchable resin 60 are formed in a plate shape and extend in the planar direction. The surface of the first stretchable resin 50 in the second thickness direction Z2 serves as the back surface 2 of the stretchable device 100. The first stretchable resin 50 has a first surface 51 facing the first thickness direction Z1. The resin base member 10 is stacked on the first surface 51.

The surface of the second stretchable resin 60 in the first thickness direction Z1 serves as the surface 1 of the stretchable device 100. A surface 61 of the second stretchable resin 60 in the second thickness direction Z2 adheres to the array layer 30. The ends of the second stretchable resin 60 in the longitudinal direction X and in the intersecting direction Y are provided with a frame part 62 that protrudes in the second thickness direction Z2 from the surface 61.

The frame part 62 is formed in an annular shape in plan view and surrounds the outer periphery of the resin base member 10 and the array layer 30. A surface 62a of the frame part 62 in the second thickness direction Z2 adheres to the first surface 51 of the first stretchable resin 50. Thus, the first stretchable resin 50 and the second stretchable resin 60 cooperate to serve as a housing that accommodates the resin base member 10 and the array layer 30.

The resin base member 10 adheres to the first surface 51 of the first stretchable resin 50. The resin base member 10 has elastic, flexible, and insulating properties. The resin base member 10 is made of resin material, such as polyimide.

As illustrated in FIG. 3, the resin base member 10 includes a plurality of bodies 11 and a plurality of hinges 12 meandering and extending in the planar direction. The body 11 has a quadrilateral (square) shape in plan view. The body 11 is disposed with its four corners facing the longitudinal direction X and the intersecting direction Y. The bodies 11 are arrayed in the longitudinal direction X and the intersecting direction Y and are separated from one another. The shape of the body 11 according to the present disclosure in plan view is not limited to a quadrilateral shape and may be circular or other polygonal shapes.

As illustrated in FIG. 3, the hinges 12 include longitudinal hinges 12A extending in the longitudinal direction X and lateral hinges 12B extending in the intersecting direction Y. When the longitudinal hinge 12A is rotated by 90 degrees in plan view, it has the same shape as that of the lateral hinge 12B. In the following description of the hinge 12, the longitudinal hinge 12A is described as a representative example, and description of the lateral hinge 12B is omitted.

As illustrated in FIG. 4, the longitudinal hinge 12A has four bends 13 and extends in the longitudinal direction X while meandering. Each bend 13 according to the present embodiment has an arc shape. The bend according to the present disclosure does not necessarily have an arc shape and may have an angular shape. The number of bends is not limited to four.

The four bends 13 are a first arc 14, a second arc 15, a third arc 16, and a fourth arc 17 arranged in the order as listed, in the longitudinal direction X. The first arc 14 and the fourth arc 17 each form a quadrant and are bent at 90 degrees. The second arc 15 and the third arc 16 each form a semi-circular arc and are bent at 180 degrees.

As illustrated in FIG. 5, when a tensile load in the longitudinal direction X (refer to arrow C in FIG. 5) acts on the longitudinal hinge 12A, the first arc 14, the second arc 15, the third arc 16, and the fourth arc 17 are each deformed such that the curvature decreases. As a result, the distance from one end of the longitudinal hinge 12A to the other increases, and the bodies 11 move away from each other. When a compressive load in the longitudinal direction X acts on the longitudinal hinge 12A, the first arc 14, the second arc 15, the third arc 16, and the fourth arc 17 are each deformed such that the curvature increases, which is not specifically illustrated. As a result, the distance from one end of the longitudinal hinge 12A to the other decreases, and the bodies 11 move closer to each other.

As illustrated in FIG. 3, the part surrounded by the four hinges 12 disposed in an annular (square) shape is a first through hole 19 that passes through the resin base member 10 in the thickness direction. In other words, the resin base member 10 has a plurality of first through holes 19.

As illustrated in FIG. 2, the array layer 30 is provided on the surface of the resin base member 10 in the first thickness direction Z1. The array layer 30 has substantially the same shape as that of the resin base member 10 in plan view, which is not specifically illustrated. Therefore, the array layer 30 has a plurality of second through holes 31 corresponding to the first through holes 19. In the following description, the first through hole 19 and the second through hole 31 are collectively referred to as a through hole 40. As illustrated in FIG. 2, the through hole 40 is provided with a protrusion 63 protruding in the second thickness direction Z2 from the surface 61 of the second stretchable resin 60.

The array layer 30 includes a plurality of insulating layers (not illustrated) stacked in the thickness direction and an electrical circuit the insulation from the outside of which is secured by the insulating layers. The electrical circuit is, for example, a load detection circuit that detects expansion and contraction of the stretchable device 100 in the planar direction and bending of the stretchable device 100. The electrical circuit according to the present disclosure is not particularly limited and may be a force detection circuit that detects a load applied to the surface 1 or a detection circuit that detects light incident on the surface 1. The following describes the method for manufacturing the stretchable device 100 according to the first embodiment.

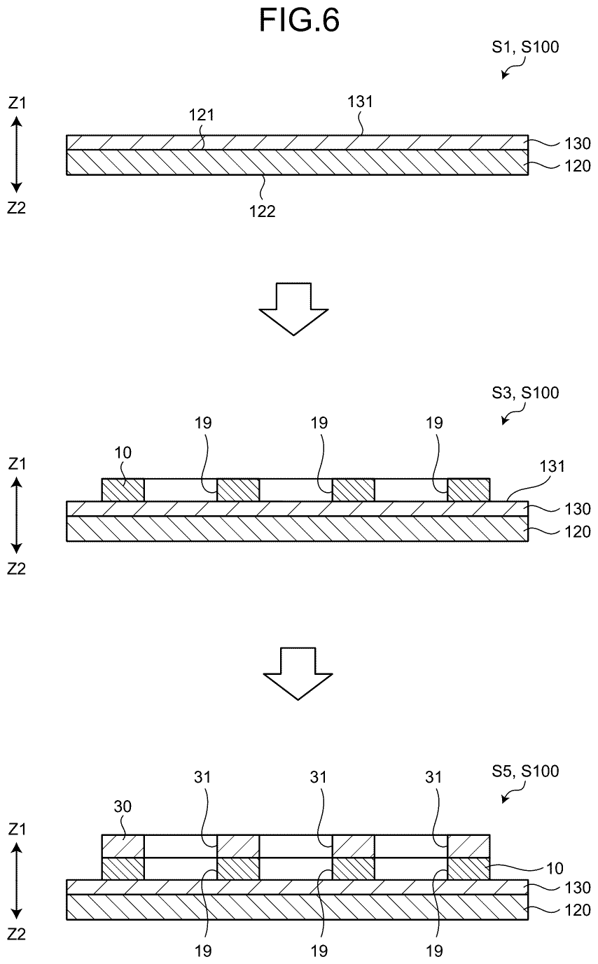

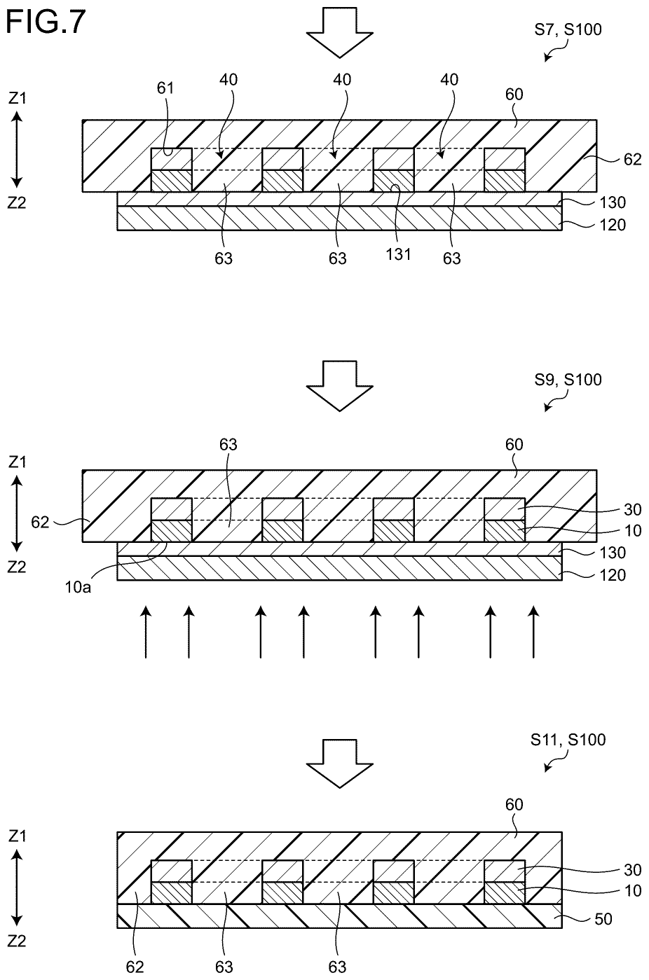

FIG. 6 is a flowchart of the first half of the method for manufacturing the stretchable device according to the first embodiment. FIG. 7 is a flowchart of the second half of the method for manufacturing the stretchable device according to the first embodiment. As illustrated in FIGS. 6 and 7, a manufacturing method S100 of the stretchable device 100 includes a preparation step S1, a resin base member formation step S3, an array layer formation step S5, a second stretchable resin arrangement step (stretchable resin arrangement step) S7, a lift-off step S9, and a first stretchable resin arrangement step S11.

As illustrated in FIG. 6, the preparation step S1 is the step of preparing a glass plate 120. The glass plate 120 has a first surface 121 facing the first thickness direction Z1 and a second surface 122 facing the second thickness direction Z2. The first surface 121 of the glass plate 120 is provided with an inorganic film 130 made of SiO. The inorganic film 130 has a formation surface 131 facing the first thickness direction Z1. The material of the inorganic film 130 according to the present disclosure is not limited to SiO. The inorganic film 130 simply needs to prevent erosion of the glass plate 120 by etching. Therefore, the inorganic film 130 may be, for example, an oxide film or an amorphous silicon film. The formation surface 131 of the inorganic film 130 will be described later in greater detail.

The resin base member formation step S3 starts with forming a solid resin layer on the formation surface 131 of the inorganic film 130 (glass plate 120). Next, a mask is placed on the surface of the resin layer in the first thickness direction Z1, and etching is performed. As a result, the first through holes 19 are formed in the resin layer, and the resin base member 10 is formed. The glass plate 120 is covered by the inorganic film 130. This configuration prevents the glass plate 120 from being eroded by etching.

The array layer formation step S5 is the step of forming the array layer 30 on the surface of the resin base member 10 in the first thickness direction Z1. The second through holes 31 continuous with the first through holes 19 are formed in the array layer 30. While the formation method employed at the array layer formation step S5 is not particularly limited in the present disclosure, the glass plate 120 is covered by the inorganic film 130 when etching is performed at the array layer formation step S5. This configuration prevents the glass plate 120 from being eroded by etching.

As illustrated in FIG. 7, the second stretchable resin arrangement step S7 starts with stacking the second stretchable resin 60 having a flat plate shape on the array layer 30 from the first thickness direction Z1. Next, the second stretchable resin 60 is pressed from the first thickness direction Z1. The pressing from the first thickness direction Z1 may be performed using a jig, such as a roller. As a result, the surface 61 of the second stretchable resin 60 adheres to the array layer 30. Due to the pressure from the first thickness direction Z1, part of the second stretchable resin 60 enters into the through holes 40 and serves as the protrusions 63. The protrusions 63 adhere to the inorganic film 130. The part of the second stretchable resin 60 positioned outside the array layer 30 in the planar direction moves in the second thickness direction Z2 due to the pressure from the first thickness direction Z1 and serves as the frame part 62. The frame part 62 also adheres to the inorganic film 130.

At the lift-off step S9, laser light is output from the second thickness direction Z2 of the glass plate 120 toward a surface 10a of the resin base member 10 in the second thickness direction Z2. Next, the resin base member 10 is removed from the glass plate 120. The irradiation with laser light creates a gap at the interface between the resin base member 10 and the inorganic film 130. Therefore, the resin base member 10 can be readily removed from the glass plate 120. If the laser light applied to the resin base member 10 is applied to the second stretchable resin 60, no gap is formed between the second stretchable resin 60 and the inorganic film 130. In other words, the second stretchable resin 60 adheres to the inorganic film 130. Therefore, when removing the resin base member 10 from the glass plate 120 (inorganic film 130), the second stretchable resin 60 exerts adhesion on the glass plate 120 (inorganic film 130).

At the first stretchable resin arrangement step S11, the first stretchable resin 50 having a plate shape is stacked on the resin base member 10 from the second thickness direction Z2. Next, the first stretchable resin 50 is pressed from the second thickness direction Z2. As a result, the first stretchable resin 50 adheres to the resin base member 10. The second stretchable resin 60 (the frame part 62 and the protrusions 63) and the first stretchable resin 50 are bonded by adhesive. Thus, the stretchable device 100 is completed. The following describes the formation surface 131 of the inorganic film 130 in detail.

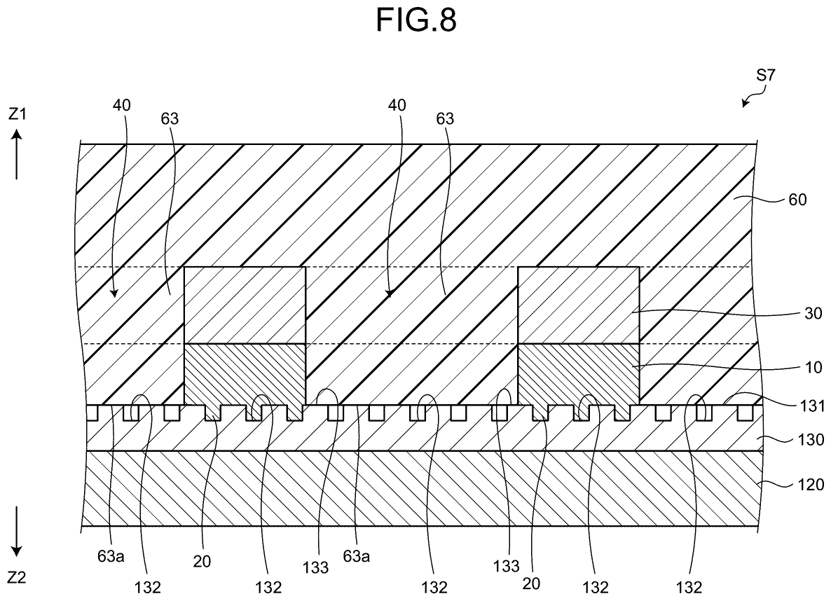

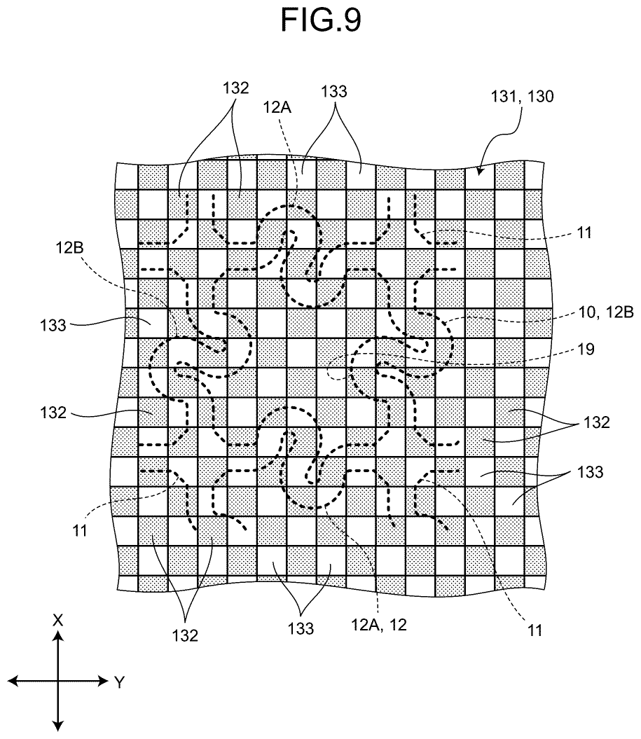

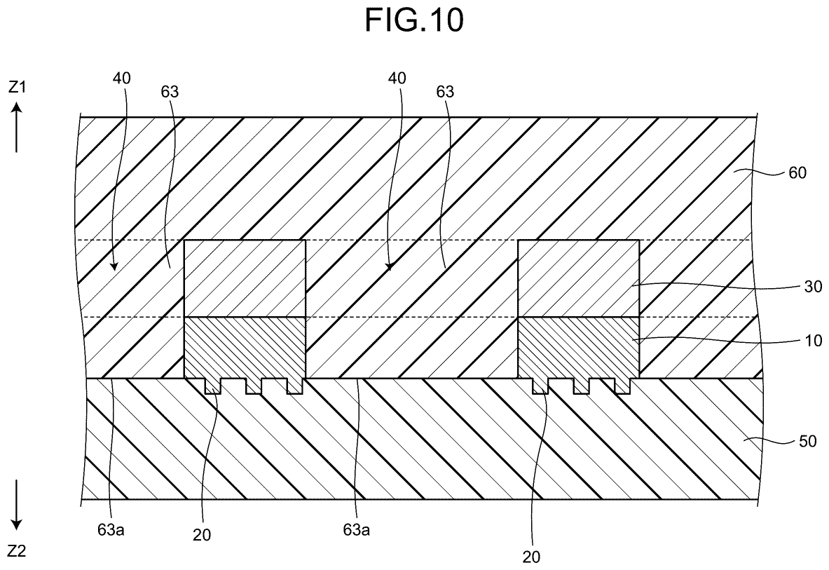

FIG. 8 is an enlarged view of a section cut in the thickness direction of an intermediate product at the second stretchable resin arrangement step. FIG. 9 is an enlarged view of the glass plate according to the first embodiment viewed from the first thickness direction. FIG. 10 is an enlarged view of a section of the stretchable device manufactured by the manufacturing method according to the first embodiment.

As illustrated in FIG. 8, the formation surface 131 of the inorganic film 130 has recesses 132 recessed in the second thickness direction Z2 (toward the glass plate 120). The depth of the recess 132 falls within a range of tens to hundreds of nanometers.

As illustrated in FIG. 9, the recess 132 is formed in a rectangular (square) shape in plan view. A plurality of recesses 132 are formed in the entire formation surface 131 of the inorganic film 130. The recesses 132 are equally spaced in the longitudinal direction X and the planar direction. Therefore, flat surfaces 133 serving as part of the formation surface 131 and having a rectangular (square) shape in plan view are provided between the recesses 132. Thus, the formation surface 131 has the recesses 132 and the flat surfaces 133 alternately arranged in the longitudinal direction X and the planar direction. While the interval between the recesses 132 is 100 nanometers, for example, the present disclosure is not limited thereto.

In the manufacturing method S100 according to the first embodiment described above, the glass plate 120 is covered by the inorganic film 130. If etching is performed at the resin base member formation step S3 and the array layer formation step S5, the glass plate 120 is not eroded. Therefore, contamination of the chamber is prevented. In addition, the recesses 132 formed in the inorganic film 130 reduces the adhesive area between the second stretchable resin 60 (the frame part 62 and the protrusions 63) and the formation surface 131. In other words, the second stretchable resin 60 has low adhesion to the inorganic film 130. Therefore, when removing the resin base member 10 from the glass plate at the lift-off step S9, the second stretchable resin 60 is readily removed from the inorganic film 130 to prevent damage or the like to the resin base member 10 and the array layer 30.

The recesses 132 according to the first embodiment are formed in the entire formation surface 131. Therefore, when the resin layer is formed at the resin base member formation step S3, the resin enters into the recesses 132. The resin that enters into the recess 132 serves as a protrusion 20 (refer to FIG. 8) that protrudes from the surface 10a of the resin base member 10 in the second thickness direction Z2. This protrusion 20 has a shape corresponding to the recess 132 and is a square prism. As illustrated in FIG. 10, when the first stretchable resin 50 is pressed from the second thickness direction Z2 at the first stretchable resin arrangement step S11, the first stretchable resin 50 enters between the protrusions 20. Therefore, the protrusions 20 are buried in the first surface 51 of the first stretchable resin 50. The protrusions 20 are not illustrated in FIG. 2 and other figures.

While the first embodiment has been described above, the shape and the position of the recesses 132 formed in the inorganic film 130 are not limited to those described in the first embodiment. The following describes first to third modifications in which the shape and the position of the recesses 132 are changed.

### First Modification

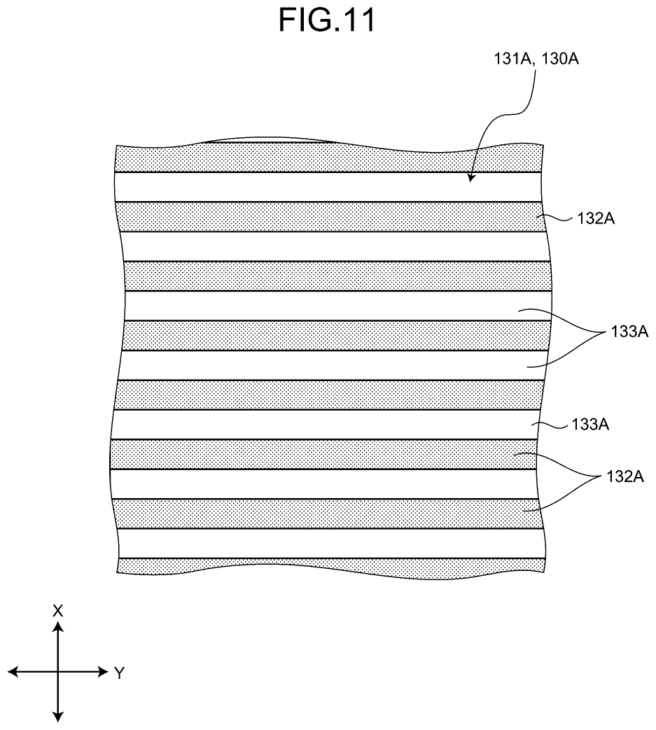

FIG. 11 is an enlarged view of part of the formation surface of the inorganic film according to a first modification viewed from the first thickness direction. As illustrated in FIG. 11, a recess 132A of an inorganic film 130A according to the first modification extends in the intersecting direction Y and is formed in a groove shape. A plurality of recesses 132A are formed in a manner spaced apart from each other in the longitudinal direction X. Therefore, flat surfaces 133A serving as part of the formation surface 131A and extending in the intersecting direction Y are provided between the recesses 132A. Thus, the formation surface 131A according to the first modification has the recesses 132A and the flat surfaces 133A alternately arranged in the longitudinal direction X, thereby having a smaller adhesive area with the second stretchable resin 60. Also in the first modification, the second stretchable resin 60 has low adhesion to the inorganic film 130A. When removing the resin base member 10 from the glass plate, the second stretchable resin 60 is readily removed from the inorganic film 130A.

### Second Modification

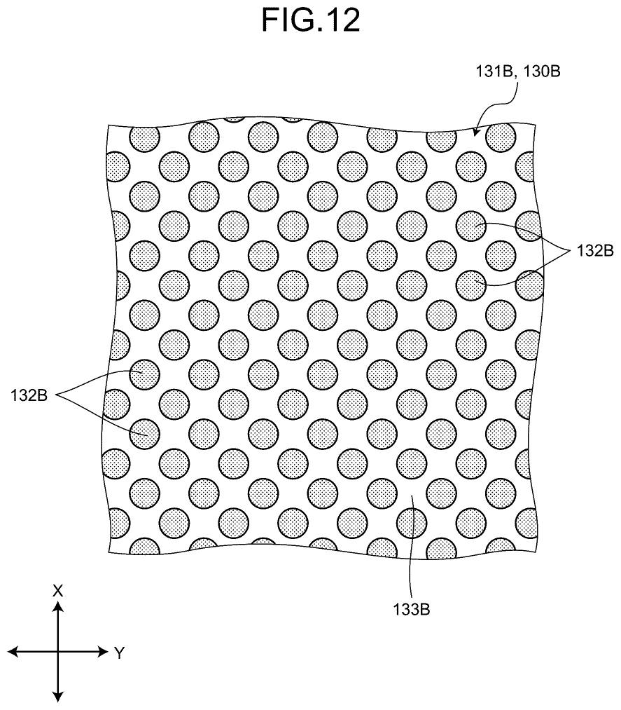

FIG. 12 is an enlarged view of part of the formation surface of the inorganic film according to a second modification viewed from the first thickness direction. As illustrated in FIG. 12, recesses 132B are formed in a formation surface 131B of an inorganic film 130B according to the second modification. The recess 132B is formed in a circular shape when viewed from the first thickness direction Z1. A plurality of recesses 132B are formed. The recesses 132B are arranged in a triangular lattice (equilateral triangular lattice). The formation surface 131B according to the second modification also has a smaller adhesive area with the second stretchable resin 60. Therefore, when removing the resin base member 10 from the glass plate, the second stretchable resin 60 is readily removed from the inorganic film 130B. The part (flat surface 133B) where the recesses 132B are not formed is continuous in the planar direction.

### Third Modification

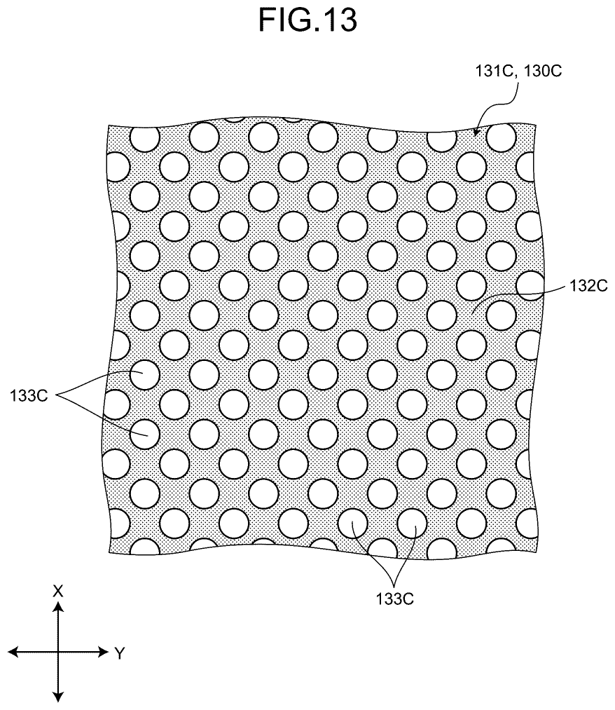

FIG. 13 is an enlarged view of part of the formation surface of the inorganic film according to a third modification viewed from the first thickness direction. As illustrated in FIG. 13, a recess 132C is formed in a formation surface 131C of an inorganic film 130C according to the third modification. The recess 132C is a single recess. The recess 132C extends in the planar direction and is formed in the entire formation surface 131C. The part where the recess 132C is not formed is flat surfaces 133C serving as part of the formation surface 131C. The flat surface 133C is formed in a circular shape when viewed from the first thickness direction Z1. A plurality of flat surfaces 133C are provided. The flat surfaces 133C are arranged in a triangular lattice (equilateral triangular lattice). The formation surface 131C according to the third modification also has a smaller adhesive area with the second stretchable resin 60. Therefore, when removing the resin base member 10 from the glass plate, the second stretchable resin 60 is readily removed from the inorganic film 130C.

While the first embodiment and the modifications have described an example where the recesses are formed in the entire formation surface, the present disclosure is not limited thereto. The following describes a second embodiment where the recesses are formed in part of the formation surface.

### Second Embodiment

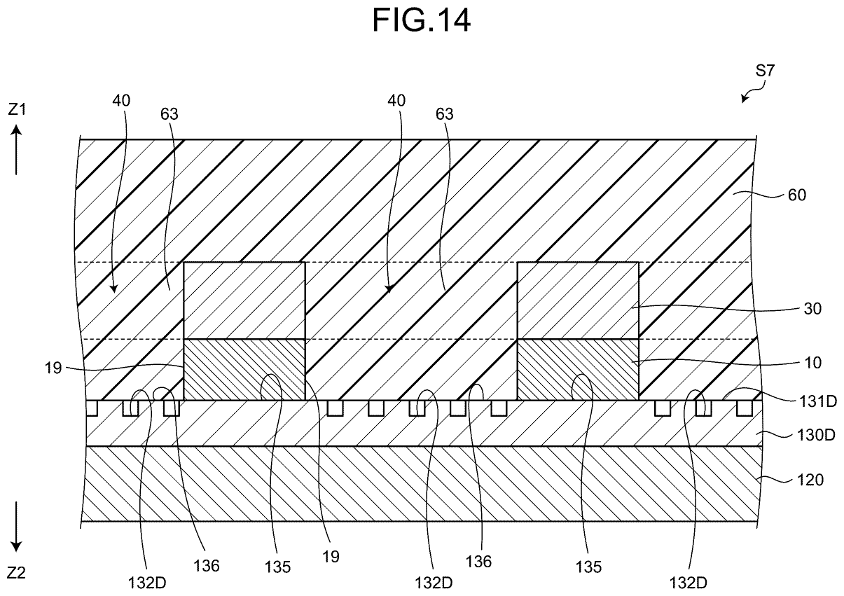

FIG. 14 is a sectional view cut in the thickness direction of an intermediate product after the second stretchable resin arrangement step in the manufacturing method according to the second embodiment. A formation surface 131D of an inorganic film 130D used in the manufacturing method according to the second embodiment has a covered portion 135 in contact with the resin base member 10 and an exposed portion 136 not in contact with the resin base member 10.

The covered portion 135 is covered by the resin base member 10 from the first thickness direction Z1. The exposed portion 136 is not covered by the resin base member 10 from the first thickness direction Z1. Specifically, the exposed portion 136 is a part overlapping the first through hole 19 (through hole 40) in the thickness direction and a part positioned outside the resin base member 10 in the planar direction. The part of the exposed portion 136 overlapping the first through hole 19 in the thickness direction adheres to the protrusion 63 of the second stretchable resin 60. The part of the exposed portion 136 positioned outside the resin base member 10 in the planar direction adheres to the frame part 62 (refer to FIG. 2) of the second stretchable resin 60. Recesses 132D according to the present embodiment are formed only in the exposed portion 136. Therefore, the covered portion 135 is formed flat.

In the manufacturing method according to the second embodiment described above, the formation surface 131D of the inorganic film 130D has the recesses 132D only in the part adhering to the second stretchable resin 60. Therefore, similarly to the first embodiment, when removing the resin base member 10 from the glass plate, the second stretchable resin 60 is readily removed from the inorganic film 130D.

The recesses according to the first embodiment are formed in the entire formation surface 131, and the boundary (interface) where the resin base member 10 is in contact with the formation surface 131 is not flat. When the laser light is output at the lift-off step S9, it is difficult to uniformly irradiate the interface between the resin base member 10 and the formation surface 131 with the laser light. By contrast, the interface between the resin base member 10 and the covered portion 135 according to the second embodiment is flat. Therefore, the interface between the resin base member 10 and the covered portion 135 can be uniformly irradiated with the laser light. As a result, the resin base member 10 has higher removability than in the manufacturing method according to the first embodiment.

What is claimed is:

1. A method for manufacturing a stretchable device, the method comprising:
preparing a glass plate provided with an inorganic film;
forming a resin base member on the inorganic film;
forming an array layer on the resin base member; and
bonding a stretchable resin to the array layer, wherein
the bonding the stretchable resin includes arranging part of the stretchable resin in a through hole that passes through the resin base member and the array layer and bonding the part of the stretchable resin to the inorganic film,
the inorganic film has a formation surface on which the resin base member is formed, and
the formation surface has a recess recessed toward the glass plate.

2. The method for manufacturing a stretchable device according to claim 1, wherein the recess is formed in the entire formation surface.

3. The method for manufacturing a stretchable device according to claim 1, wherein
the formation surface has:
a covered portion covered by the resin base member; and
an exposed portion not covered by the resin base member, the part of the stretchable resin being bonded to the exposed portion, and
the recess is formed only in the exposed portion.
